(19) United States
(12) Patent Application Publication
(10) Pub. No.: US 2026/0052601 A1
(43) Pub. Date: Feb. 19, 2026

(54) METHOD AND APPARATUS FOR POWER CONSUMPTION SAVING OF TERMINAL

(71) Applicant: ELECTRONICS AND TELECOMMUNICATIONS RESEARCH INSTITUTE, Daejeon (KR)

(72) Inventors: Hyun Seo PARK, Daejeon (KR); Yong Jin KWON, Daejeon (KR); Yunjoo KIM, Daejeon (KR); Seungjae BAHNG, Daejeon (KR); Jungbo SON, Daejeon (KR); Youngjoon YOON, Daejeon (KR); Anseok LEE, Daejeon (KR); Yu Ro LEE, Daejeon (KR); Jungsook BAE, Daejeon (KR); Heesoo LEE, Daejeon (KR)

(73) Assignee: ELECTRONICS AND TELECOMMUNICATIONS RESEARCH INSTITUTE, Daejeon (KR)

(21) Appl. No.: 19/253,412

(22) Filed: Jun. 27, 2025

(30) Foreign Application Priority Data
Jun. 28, 2024 (KR) 10-2024-0085773
Jun. 27, 2025 (KR) 10-2025-0085963

(51) Int. Cl. H04W 76/28; H04W 72/23

(52) U.S. Cl. CPC H04W 76/28; H04W 72/23

(57) ABSTRACT

Disclosed are methods and apparatuses for reducing power consumption of a terminal. A method of a terminal may comprise: receiving, from a base station, discontinuous reception (DRX) configuration information; performing physical downlink control channel (PDCCH) monitoring in an active duration of a DRX cycle based on the DRX configuration information; receiving, from the base station, instruction information instructing adjustment of the active duration of the DRX cycle; adjusting a time length of the active duration based on the instruction information from the base station; and performing PDCCH monitoring in the active duration whose time length is adjusted.

### CROSS-REFERENCE TO RELATED APPLICATIONS

This application claims priority to Korean Patent Applications No. 10-2024-0085773, filed on Jun. 28, 2024, and No. 10-2025-0085963, filed on Jun. 27, 2025, with the Korean Intellectual Property Office (KIPO), the entire contents of which are hereby incorporated by reference.

### BACKGROUND

### 1. Technical Field

The present disclosure relates to a communication protocol of a terminal, and more particularly, to a method and an apparatus for saving power consumption in a discontinuous reception (DRX) operation of a terminal in a communication network.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In the above-described communication network, a terminal may receive radio resource allocation information from a base station and may receive downlink (DL) data or transmit uplink (UL) data using allocated radio resources.

The terminal may monitor reception of a physical downlink control channel (PDCCH) from the base station every slot or subframe in order to receive the radio resource allocation information. As the terminal performs the PDCCH monitoring operation, power consumption, for example, the power consumption of the terminal, may increase. The terminal may apply a discontinuous reception (DRX) function to reduce power consumption.

The base station may configure the DRX function of the terminal, and the terminal may receive an execution command including DRX configuration information from the base station. The terminal may perform a DRX operation based on the DRX configuration information and may repeat an active duration and a sleep duration in each preconfigured cycle, for example, a DRX cycle. The terminal may monitor PDCCH reception from the base station in the active duration and may not monitor PDCCH reception in the sleep duration. Since the terminal does not perform PDCCH monitoring during the sleep duration, power consumption may be minimized. However, when the base station has data to transmit to the terminal during the sleep duration, data transmission delay may increase because PDCCH monitoring of the terminal does not occur. Accordingly, a solution is required that can reduce power consumption of the terminal while preventing data transmission delay.

### SUMMARY

The present disclosure for resolving the above-described problems is directed to providing a method and an apparatus for reducing power consumption by dynamically controlling DRX operations of a terminal.

A method of a terminal for reducing power consumption, according to an exemplary embodiment of the present disclosure, may comprise: receiving, from a base station, discontinuous reception (DRX) configuration information; performing physical downlink control channel (PDCCH) monitoring in an active duration of a DRX cycle based on the DRX configuration information; receiving, from the base station, instruction information instructing adjustment of the active duration of the DRX cycle; adjusting a time length of the active duration based on the instruction information from the base station; and performing PDCCH monitoring in the active duration whose time length is adjusted.

The adjusting of the time length of the active duration may comprise: receiving, from the base station, a radio resource control (RRC) reconfiguration including extension time information of the active duration; receiving, from the base station, an extension instruction for the active duration; and extending the time length of the active duration based on the extension time information according to the extension instruction.

The adjusting of the time length of the active duration may comprise: receiving, from the base station, an RRC reconfiguration including short inactivity timer information; receiving, from the base station, a final data scheduling indication for the active duration; and reducing the time length of the active duration based on the short inactivity timer information according to the final data scheduling indication.

The method may further comprise: controlling the DRX cycle by receiving information instructing an update of the DRX cycle from the base station.

The controlling of the DRX cycle may comprise: receiving, from the base station, an RRC reconfiguration including update information for the DRX cycle; receiving, from the base station, an update instruction for the DRX cycle; and increasing or decreasing the DRX cycle based on the update information according to the update instruction.

The DRX configuration information may include a first reference value and a second reference value set for a number of PDCCH receptions during the DRX cycle, and the controlling of the DRX cycle may comprise: determining a number of receptions of PDCCHs transmitted from the base station during the DRX cycle; and decreasing a DRX cycle index when the number of receptions of PDCCHs is equal to the first reference value, and increasing the DRX cycle index when the number of receptions of PDCCHs is equal to the second reference value.

The method may further comprise: receiving, from the base station, an RRC reconfiguration including a DRX assistance information request; and transmitting, to the base station, user equipment (UE) assistance information including at least one DRX assistance information, wherein the DRX configuration information is determined based on the at least one DRX assistance information.

The at least one DRX assistance information may include at least one of: battery state information, data reception state information, scheduling policy preference information, or paging policy preference information of the terminal.

The performing of the PDCCH monitoring in the active duration may comprise: in response to the terminal transitioning from an RRC connected state to an active sleep state, receiving a DRX operation instruction from the base station; and performing the PDCCH monitoring in the active duration based on the DRX configuration information according to the DRX operation instruction.

A terminal for reducing power consumption, according to an exemplary embodiment of the present disclosure, may comprise at least one processor. The at least one processor may cause the terminal to perform: receiving, from a base station, discontinuous reception (DRX) configuration information; performing physical downlink control channel (PDCCH) monitoring in an active duration of a DRX cycle based on the DRX configuration information; receiving, from the base station, instruction information instructing adjustment of the active duration of the DRX cycle; adjusting a time length of the active duration based on the instruction information from the base station; and performing PDCCH monitoring in the active duration whose time length is adjusted.

In the adjusting of the time length of the active duration, the at least one processor may cause the terminal to perform: receiving, from the base station, a radio resource control (RRC) reconfiguration including extension time information of the active duration; receiving, from the base station, an extension instruction for the active duration; and extending the time length of the active duration based on the extension time information according to the extension instruction.

In the adjusting of the time length of the active duration, the at least one processor may cause the terminal to perform: receiving, from the base station, an RRC reconfiguration including short inactivity timer information; receiving, from the base station, a final data scheduling indication for the active duration; and reducing the time length of the active duration based on the short inactivity timer information according to the final data scheduling indication.

The at least one processor may further cause the terminal to perform: controlling the DRX cycle by receiving information instructing an update of the DRX cycle from the base station.

In the controlling of the DRX cycle, the at least one processor may cause the terminal to perform: receiving, from the base station, an RRC reconfiguration including update information for the DRX cycle; receiving, from the base station, an update instruction for the DRX cycle; and increasing or decreasing the DRX cycle based on the update information according to the update instruction.

The at least one processor may further cause the terminal to perform: receiving, from the base station, an RRC reconfiguration including a DRX assistance information request; and transmitting, to the base station, user equipment (UE) assistance information including at least one DRX assistance information, wherein the DRX configuration information is determined based on the at least one DRX assistance information.

The at least one DRX assistance information may include at least one of: battery state information, data reception state information, scheduling policy preference information, or paging policy preference information of the terminal.

In the performing of the PDCCH monitoring in the active duration, the at least one processor may cause the terminal to perform: in response to the terminal transitioning from an RRC connected state to an active sleep state, receiving a DRX operation instruction from the base station; and performing the PDCCH monitoring in the active duration based on the DRX configuration information according to the DRX operation instruction.

A method of a base station for reducing power consumption, according to an exemplary embodiment of the present disclosure, may comprise: determining discontinuous reception (DRX) configuration information of a terminal; transmitting the DRX configuration information to the terminal; predicting whether a physical downlink control channel (PDCCH) is to be scheduled in an inactive duration of a DRX cycle of the terminal; and based on a prediction that a PDCCH is to be scheduled in the inactive duration, transmitting information instructing extension of an active duration to the terminal, and based on a prediction that a PDCCH is not to be scheduled in the inactive duration, transmitting information indicating a final data scheduling for the active duration to the terminal.

The method may further comprise: transmitting an RRC reconfiguration to the terminal, the RRC reconfiguration including update information for increasing or decreasing the DRX cycle; monitoring a number of PDCCH schedulings for the active duration of the DRX cycle; and transmitting an update instruction of the DRX cycle to the terminal based on the number of monitored PDCCH schedulings.

The method may further comprise: transmitting an RRC reconfiguration including a DRX assistance information request to the terminal; and receiving user equipment (UE) assistance information including at least one DRX assistance information from the terminal, wherein the DRX configuration information is determined based on the at least one DRX assistance information.

According to the present disclosure, the terminal may increase or decrease an on-duration of an active duration based on information indicating adjustment of the active duration of a DRX cycle received from the base station. Therefore, the terminal can receive a PDCCH transmitted from the base station through the increased on-duration in the DRX cycle, thereby reducing data transmission delay. Furthermore, the terminal can quickly enter an inactive duration through the decreased on-duration in the DRX cycle, thereby reducing power consumption in a DRX operation of the terminal.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating a power consumption pattern of a terminal in a communication network.

FIG. 4 is a conceptual diagram illustrating an exemplary embodiment of a DRX operation of a terminal.

FIG. 5 is a conceptual diagram illustrating another exemplary embodiment of the DRX operation of the terminal.

FIG. 6 is a flowchart illustrating an exemplary embodiment of a method for controlling a DRX operation of a terminal.

FIG. 7 is a sequence chart illustrating an exemplary embodiment of a method for controlling a DRX operation of a terminal.

FIG. 8 is a conceptual diagram illustrating the DRX operation of the terminal according to FIG. 7.

FIG. 9 is a sequence chart illustrating an exemplary embodiment of a method for controlling a DRX operation of a terminal.

FIG. 10 is a conceptual diagram illustrating the DRX operation of the terminal according to FIG. 9.

FIG. 11 is a flowchart illustrating an exemplary embodiment of a method for controlling a DRX operation of a terminal.

FIG. 12 is a sequence chart illustrating an exemplary embodiment of a method for controlling a DRX operation of a terminal.

FIG. 13 is a flow chart illustrating an exemplary embodiment of a method of controlling a DRX operation of a terminal.

FIG. 14 is a sequence chart illustrating an exemplary embodiment of a method of determining DRX configuration information of a terminal.

FIG. 15 is a sequence chart illustrating an exemplary embodiment of a method of determining DRX configuration information of a terminal.

FIG. 16 is a sequence chart illustrating an exemplary embodiment of a method of determining DRX configuration information of a terminal.

FIG. 17 is a sequence chart illustrating an exemplary embodiment of a method of determining DRX configuration information of a terminal.

FIG. 18 is a sequence chart illustrating an exemplary embodiment of a method of determining DRX configuration information of a terminal.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B”or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

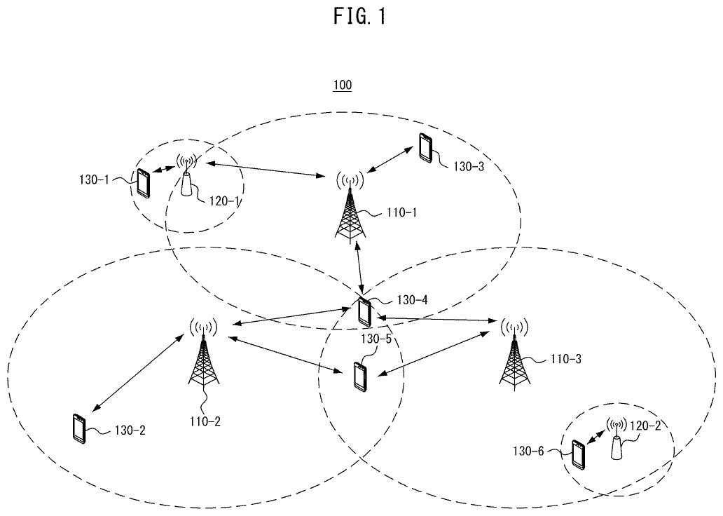

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

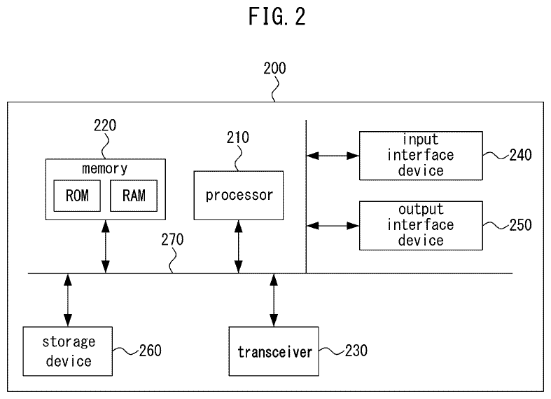

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, each of the plurality of terminals 130-1, 130-2, 130-3, 130-4, 130-5, and 130-6 in the communication network 100 may receive radio resource allocation information from a corresponding base station among the plurality of base stations 110-1, 110-2, 110-3, 120-1, and 120-2. Each terminal may receive downlink (DL) data from a base station or transmit uplink (UL) data to the base station based on the received radio resource allocation information.

The terminal may monitor reception of a physical downlink control channel (PDCCH) from the base station in order to receive the radio resource allocation information. The PDCCH reception monitoring operation of the terminal may increase the power consumption of the terminal. The terminal may perform a discontinuous reception (DRX) operation to minimize power consumption.

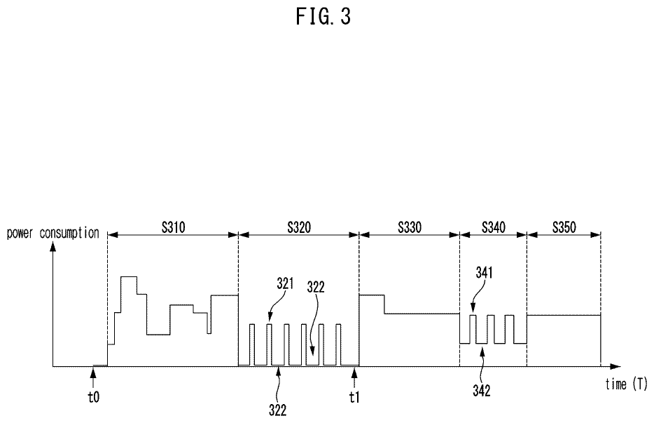

FIG. 3 is a conceptual diagram illustrating a power consumption pattern of a terminal in a communication network.

Referring to FIG. 3, a terminal may transition from a power-off state to a power-on state at a time t0. The terminal may perform initialization for establishing communication with a base station through a booting procedure, and may perform an initial access procedure between the terminal and the base station (S310).

The terminal may perform initialization by performing the booting procedure. The initialized terminal may acquire frequency synchronization through scanning of frequency bands and may configure a communication frequency band with the base station based on the acquired frequency synchronization.

For example, the terminal may scan frequency bands based on a location of the terminal within allowed frequency bands. The terminal may receive synchronization signal/physical broadcast channel (SS/PBCH) blocks periodically broadcasted from the base station based on the frequency band scanning. The SS/PBCH block may be referred to as a synchronization signal block (SSB).

The terminal may acquire a master information block (MIB) from the received SS/PBCH block and may obtain information on a frequency bandwidth from the MIB. The terminal may acquire frequency synchronization based on the information on the frequency bandwidth and may configure a frequency band for communication.

The terminal may search for a plurality of cells around the terminal based on the configured frequency band. The terminal may select at least one cell to camp on among the plurality of cells that have been searched.

For example, the terminal may receive a PDCCH within a control resource set (CORESET) and a search space indicated by the MIB, and may receive a physical downlink shared channel (PDSCH) scheduled by the PDCCH. The terminal may acquire a system information block 1 (SIB1) from the received PDSCH. The SIB1 may include random access (RA) information, public land mobile network (PLMN) information, cell selection criteria information, or other system information (OSI). The terminal may identify a PLMN based on the SIB1 and may identify whether the selected cell satisfies predetermined criteria, for example, cell selection criteria. The terminal may complete the cell selection when the selected cell satisfies the predetermined criteria.

The terminal may perform an initial access procedure for call setup with respect to the selected cell. The terminal may transition to a radio resource control (RRC) connected state through the initial access procedure. The initial access procedure may be classified into a four-step random access (RA) procedure or a two-step RA procedure.

For example, the terminal may identify random access channel (RACH) occasions (ROs) based on RACH configuration information included in the SIB1. The terminal may select an RO based on an index of a preamble to transmit, and may transmit a first message (Msg1) in the selected RO. The base station may receive the first message from the terminal and may transmit a second message (Msg2) to the terminal in response. The second message may include a random access response (RAR). The terminal may receive the second message from the base station and may transmit a third message (Msg3) to the base station using a physical uplink shared channel (PUSCH) indicated by a UL grant field of the second message. The third message may be an RRC connection request message. The base station may receive the third message from the terminal and may transmit a fourth message (Msg4) to the terminal in response. The fourth message may be an RRC connection setup message.

After the initial access procedure of the terminal is completed, data transmission and reception between the terminal and the base station may not occur for a certain time. In this case, the terminal may transition from the RRC connected state to an inactive state, for example, an RRC idle state. The terminal may perform a paging procedure with the base station in the RRC idle state (S320).

The terminal may perform a DRX operation, for example, an IDLE mode DRX operation, in the paging stage S320 to reduce power consumption. The paging stage S320 of the terminal may include a plurality of paging cycles. Each of the plurality of paging cycles may include an active duration 321 and an inactive duration 322.

The terminal may wake up in the active duration 321 in the paging stage S320, and may attempt to receive a paging signal (or paging message) from the base station during a preconfigured on-duration time.

When a paging signal is not received during the active duration 321, the terminal may enter the inactive duration 322. The terminal may transition to a sleep state in the inactive duration 322, and the sleep state of the terminal may be maintained for a preconfigured off-duration time.

The terminal may receive a paging signal from the base station at a time t1. The terminal may wake up based on the received paging signal and may transition from the RRC idle state to the RRC connected state. The terminal may perform a data communication procedure through call setup with the base station in the RRC connected state (S330).

The terminal may receive a DL signal from the base station or may transmit a UL signal to the base station. In the data communication stage S330, when data transmission and reception between the terminal and the base station do not occur for a certain time, the terminal may enter an active sleep stage S340. In this case, the terminal may maintain the RRC connected state.

The terminal may perform a DRX operation, for example, a connected mode DRX (C-DRX) operation, in the active sleep stage S340 to reduce power consumption. The active sleep stage S340 of the terminal may include an active duration 341 and an inactive duration 342 that are repeated in each preconfigured DRX cycle.

The terminal may wake up in the active duration 341 of the active sleep stage S340 and may monitor reception of a PDCCH from the base station during an on-duration time.

When a PDCCH is not received during the active duration 341, the terminal may enter the inactive duration 342. The terminal may transition to a sleep state in the inactive duration 342, and the sleep state of the terminal may be maintained for an off-duration time.

The terminal may receive a PDCCH transmitted from the base station in the active duration 341. The terminal may transition again from the active sleep stage 341 to a data communication stage S350 and may perform data transmission and reception with the base station.

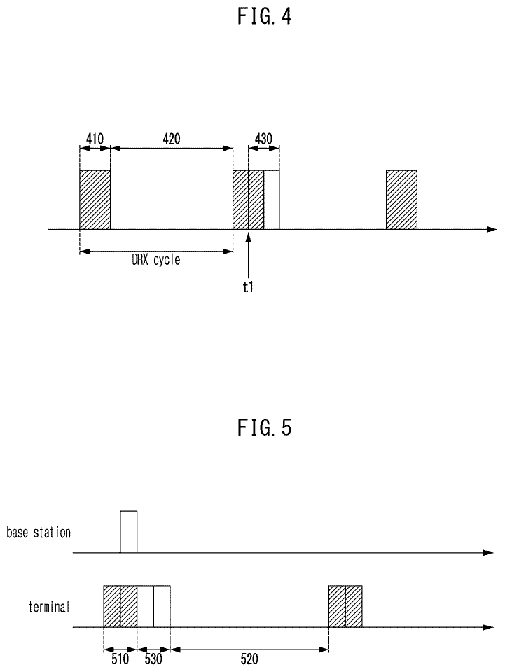

FIG. 4 is a conceptual diagram illustrating an exemplary embodiment of a DRX operation of a terminal, and FIG. 5 is a conceptual diagram illustrating another exemplary embodiment of the DRX operation of the terminal.

Although FIGS. 4 and 5 illustrate a connected mode DRX (C-DRX) operation in the RRC connected state of the terminal, the present disclosure is not limited thereto. For example, FIGS. 4 and 5 may be equally applied to the IDLE mode DRX operation in the RRC idle state of the terminal.

Referring to FIG. 4, the terminal may wake up in an active duration 410 that is repeated in each preconfigured DRX cycle. The terminal may monitor a PDCCH transmitted from the base station during a preconfigured on-duration time.

The terminal may receive a PDCCH from the base station at a time t1 of the active duration 410. The terminal may enter an inactivity timer duration 430 in which an inactivity timer operates based on the received PDCCH. The terminal may maintain the current active duration 410 based on a time length of the inactivity timer duration 430 until the inactivity timer expires. Accordingly, the terminal may increase a time length of the active duration 410, that is, the on-duration time, during the DRX cycle.

The terminal may not receive a PDCCH during the active duration 410. When the active duration 410 ends, the terminal may enter the inactive duration 420, transition to a sleep state, and reduce power consumption.

The base station may configure a DRX operation for the terminal and may transmit DRX configuration information to the terminal. The DRX configuration information may include information on a DRX cycle (e.g. drx-LongCycle), an on-duration timer (e.g. drx-onDurationTimer), or a DRX inactivity timer (e.g. drx-InactivityTimer).

For example, as illustrated in FIG. 5, the base station may transmit the DRX configuration information including a DRX cycle of 10 milliseconds (ms), an on-duration timer of 2 ms, and a DRX inactivity timer of 2 ms to the terminal. The terminal may monitor reception of a PDCCH during an on-duration time of an active duration 510 configured based on the DRX configuration information.

The terminal may receive a PDCCH in the active duration 510. When the active duration 510 ends, the terminal may enter an inactivity timer duration 530 configured based on the DRX configuration information, and may maintain the current active duration 510 while the DRX inactivity timer is operating. Accordingly, the time of the active duration 510 may be increased by a time during which the DRX inactivity timer operates, that is, the time of the inactivity timer duration 530. The terminal may enter an inactive duration 520 when the DRX inactivity timer expires and may transition to a sleep state.

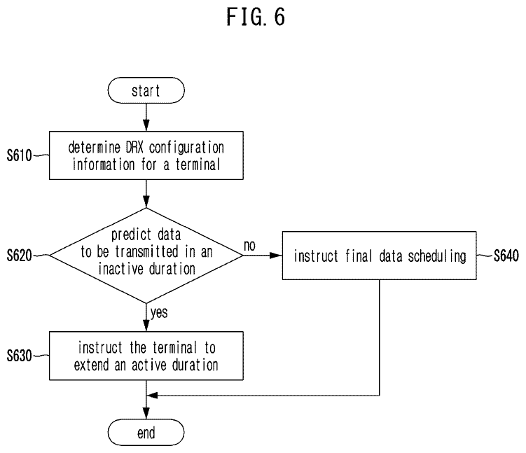

FIG. 6 is a flowchart illustrating an exemplary embodiment of a method for controlling a DRX operation of a terminal.

Referring to FIG. 6, the base station may determine configuration information for a DRX operation of the terminal and may transmit the determined DRX configuration information to the terminal (S610). The DRX configuration information of the terminal may include information on each of a DRX cycle, an on-duration timer, or a DRX inactivity timer.

The terminal may transition from an RRC connected state to an active sleep state. The base station may instruct the terminal to perform a DRX operation, for example, a connected mode DRX (C-DRX) operation, and the terminal may perform the DRX operation based on the received DRX configuration information. The base station may predict whether data is to be transmitted (e.g. data is to be scheduled by a PDCCH) in an inactive duration of a DRX cycle while the terminal is performing the DRX operation (S620).

The base station may control the DRX operation of the terminal based on a prediction result. For example, the base station may predict that a PDCCH is to be scheduled in the inactive duration, and based on the prediction result, the base station may instruct the terminal to extend the active duration (S630). In addition, the base station may predict that a PDCCH is not to be scheduled in the inactive duration, and based on the prediction result, the base station may indicate final data scheduling for a PDCCH transmitted to the terminal (S640).

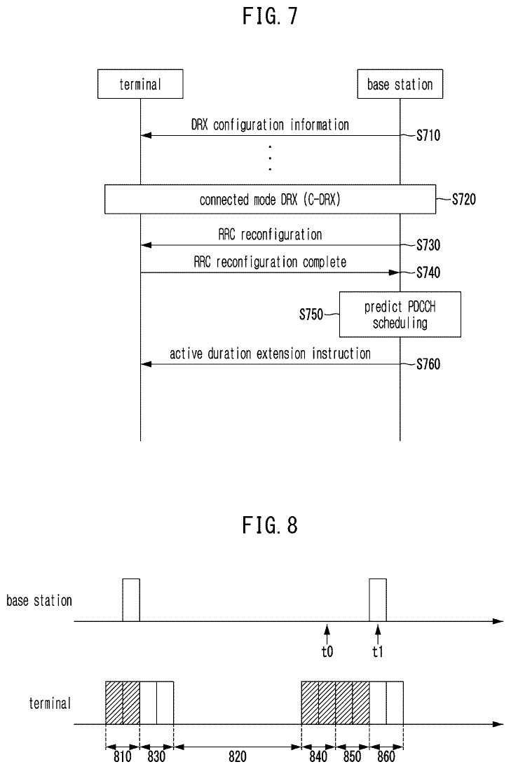

FIG. 7 is a sequence chart illustrating an exemplary embodiment of a method for controlling a DRX operation of a terminal, and FIG. 8 is a conceptual diagram illustrating the DRX operation of the terminal according to FIG. 7.

Referring to FIG. 7, in order to extend an active duration of a DRX cycle for controlling a DRX operation of a terminal, the base station may perform two-step signaling to the terminal, for example, an RRC reconfiguration request and a PDCCH DCI. The RRC reconfiguration request may include active duration extension time information. The PDCCH DCI may include an indication for active duration extension.

The base station may determine DRX configuration information for the terminal and may transmit the DRX configuration information to the terminal (S710). The DRX configuration information may include information on each of a DRX cycle, an on-duration timer, or a DRX inactivity timer. Referring to FIG. 8, the base station may set the DRX cycle to 10 ms, the on-duration timer of the active duration to 2 ms, and the DRX inactivity timer of the inactivity timer duration to 2 ms. The base station may transmit the DRX configuration information including configuration for each of the DRX cycle, the on-duration timer, or the DRX inactivity timer to the terminal.

The terminal may perform data communication with the base station in the RRC connected state, and after a certain time, may transition to an active sleep state in the RRC connected state. The base station may instruct the terminal to perform a DRX operation, for example, a connected mode DRX (C-DRX) operation, and the terminal may perform the DRX operation based on the received DRX configuration information (S720). As illustrated in FIG. 8, the terminal may perform the DRX operation in an active sleep state including active durations 810 and 840, inactivity timer durations 830 and 860, and an inactive duration 820.

The base station may transmit an RRC reconfiguration request to the terminal (S730). The RRC reconfiguration request may include configuration information for an extension time of the active duration 810 of the terminal, for example, active duration extension time information. The extension time information may include one or more extension times. The extension time information may be included in a PDCCH configuration or DRX configuration. The extension time information may indicate a time in units of slots or milliseconds. For example, the extension time information may be set to {1, 2, 4, 8}.

In FIG. 7, as one example, the base station transmits the RRC reconfiguration request to the terminal when the DRX operation of the terminal is being performed, but the present disclosure is not limited thereto. According to an exemplary embodiment, the base station may transmit the active duration extension time information together with the DRX configuration information to the terminal. According to another exemplary embodiment, the base station may broadcast an SIB including the active duration extension time information to the terminal. According to yet another exemplary embodiment, the base station and the terminal may use active duration extension time information predefined in the specifications.

The terminal may receive the RRC reconfiguration request from the base station and may transmit an RRC reconfiguration complete to the base station in response to the RRC reconfiguration request (S740). The base station may receive the RRC reconfiguration complete from the terminal and may predict whether a PDCCH is to be scheduled in the inactive duration 850 of the terminal (S750).

The base station may predict that a PDCCH is to be scheduled to the terminal in the inactive duration 850. The base station may control the DRX operation of the terminal based on the prediction result. For example, based on the prediction result, the base station may request the terminal to extend a width of the active duration 840 in one DRX cycle of the terminal, that is, a time length of the active duration 840.

The base station may transmit an active duration extension request including extension time bit information to the terminal (S760). The extension time bit information may be an index of the extension time information included in the above-described RRC reconfiguration request. The base station may transmit the active duration extension request to the terminal through a PDCCH DCI. According to an exemplary embodiment, the base station may transmit the active duration extension request to the terminal through a MAC CE.

The terminal may receive the active duration extension request from the base station and may extend the active duration in the corresponding DRX cycle based on the extension time bit information.

Referring to FIG. 8, the base station may predict at a time t0 that a PDCCH is to be transmitted to the terminal at a time t1 belonging to the inactive duration 850. The base station may transmit the active duration extension request including the extension time bit information to the terminal at the prediction time t0. For example, the extension time bit information may be set to ‘01’.

The terminal may receive the active duration extension request from the base station and, based on the extension time bit information ‘01’ included in the extension request, may select 2 among the received extension time information {1, 2, 4, 8}. The terminal may configure an extended active duration 850 of 2 slots or 2 ms after the existing active duration 840 based on the selected value 2.

The terminal may enter an inactivity timer duration 860 in which a DRX inactivity timer operates based on the DRX configuration information after the extended active duration 850. Accordingly, the terminal may maintain an on-duration for monitoring PDCCH reception during the existing active duration 840, the extended active duration 850, and the inactivity timer duration 860, and may receive a PDCCH transmitted from the base station during the on-duration.

As described above, in the present exemplary embodiment, the base station may predict whether a PDCCH is scheduled to be transmitted to the terminal in the inactive duration during the DRX operation of the terminal, and may instruct the terminal to extend the active duration when a PDCCH is predicted to be scheduled. Accordingly, the terminal may receive the PDCCH transmitted from the base station during the increased on-duration according to the extended active duration, and may prevent an increase in data transmission latency for receiving the PDCCH.

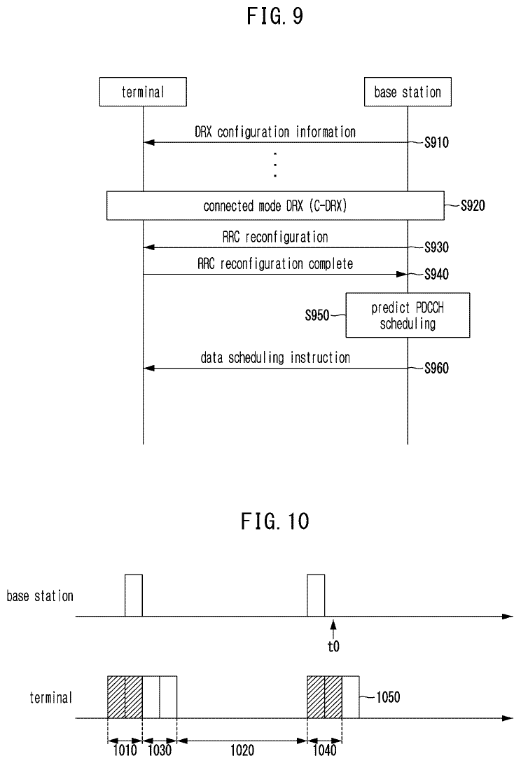

FIG. 9 is a sequence chart illustrating an exemplary embodiment of a method for controlling a DRX operation of a terminal, and FIG. 10 is a conceptual diagram illustrating the DRX operation of the terminal according to FIG. 9.

Referring to FIG. 9, for final data scheduling for DRX operation control of the terminal, the base station may perform two-step signaling to the terminal, such as an RRC reconfiguration request and a PDCCH DCI. The RRC reconfiguration request may include information on a short inactivity timer. The PDCCH DCI may include an indication for final data scheduling.

The base station may determine DRX configuration information for the terminal and may transmit the DRX configuration information to the terminal (910). The DRX configuration information may include information on each of a DRX cycle, an on-duration timer, or a DRX inactivity timer. Referring to FIG. 10, the base station may set the DRX cycle to 10 ms, the on-duration timer of an active duration to 2 ms, and the DRX inactivity timer of an inactivity timer duration to 2 ms. The base station may transmit the DRX configuration information including the configuration for each of the DRX cycle, the on-duration timer, or the DRX inactivity timer to the terminal.

The terminal may perform data communication with the base station in an RRC connected state and may transition to an active sleep state in the RRC connected state after a predetermined time. The base station may instruct the terminal to perform a DRX operation, and the terminal may perform the DRX operation based on the received DRX configuration information (S920). As illustrated in FIG. 10, the terminal may perform the DRX operation in an active sleep state including active durations 1010 and 1040, inactivity timer durations 1030 and 1050, and an inactive duration 1020.

The base station may transmit an RRC reconfiguration request to the terminal (S930). The RRC reconfiguration request may include information on a short inactivity timer for data scheduling (e.g. short-inactivity-timer).

The information on the short inactivity timer may include a time in units of slots or ms. For example, the short inactivity timer may be set to 1 slot or 1 ms. The information on the short inactivity timer may be included in a PDCCH configuration or DRX configuration.

According to an exemplary embodiment, when transmitting the DRX configuration information to the terminal, the base station may include the information on the short inactivity timer. Additionally, the base station may broadcast an SIB including the information on the short inactivity timer to the terminal, or the base station and the terminal may use the short inactivity timer predefined in the specifications.

The terminal may receive the RRC reconfiguration request from the base station and may transmit an RRC reconfiguration complete to the base station in response to the RRC reconfiguration request (S940). The base station may receive the RRC reconfiguration complete from the terminal and may predict whether a PDCCH is to be scheduled in an inactive duration of the terminal (S950).

The base station may predict that a PDCCH is not to be scheduled to the terminal in the inactive duration. The base station may control the DRX operation of the terminal based on the prediction result. For example, based on the prediction result, the base station may instruct the terminal that the PDCCH transmitted in the corresponding DRX cycle is for final data, by indicating final data scheduling (S960).

Referring to FIG. 10, the base station may predict at a time t0 that a PDCCH is not to be scheduled in the inactive duration of the DRX cycle. The base station may determine that a PDCCH transmitted at the prediction time t0 is for final data of the corresponding DRX cycle and may indicate final data scheduling to the terminal.

According to an exemplary embodiment, the base station may indicate final data scheduling to the terminal through a MAC CE. Meanwhile, when the base station indicates final data scheduling to the terminal through a PDCCH DCI, the indication may include a skip information bit for the active duration of the next DRX cycle.

The terminal may receive the final data scheduling indication from the base station. The terminal may adjust an operation time of the inactivity timer of the corresponding DRX cycle, that is, the inactivity timer duration 1050, based on the short inactivity timer information of the received RRC reconfiguration request. For example, the inactivity timer duration 1030 of the previous DRX cycle may be 2 slots or 2 ms. The terminal may receive the RRC reconfiguration request, and the short inactivity timer information included in the RRC reconfiguration request may be set to 1 slot or 1 ms. The terminal may receive the final data scheduling indication from the base station and may reduce the inactivity timer duration 1050 from 2 ms to 1 ms based on the received short inactivity timer information.

Due to the reduction of the inactivity timer duration 1050, the on-duration of the corresponding DRX cycle may be reduced, and the length of the inactive duration may be relatively increased. When the inactivity timer duration 1050 ends, the terminal may enter the inactive duration and transition to a sleep state.

As described above, in this exemplary embodiment, the base station may predict whether a PDCCH is to be scheduled to be transmitted to the terminal in the inactive duration during the DRX operation of the terminal, and when it is predicted that a PDCCH is not to be scheduled, the base station may indicate final data scheduling in the corresponding DRX cycle. Accordingly, the terminal may reduce the on-duration based on the final data scheduling indication and may enter the relatively increased inactive duration to reduce power consumption of the terminal.

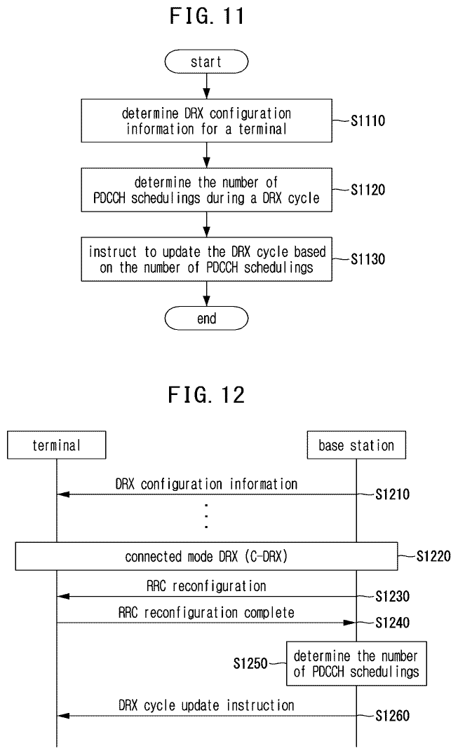

FIG. 11 is a flowchart illustrating an exemplary embodiment of a method for controlling a DRX operation of a terminal.

Referring to FIG. 11, the base station may determine configuration information for the DRX operation of the terminal and may transmit the determined DRX configuration information to the terminal (S1110). The DRX configuration information of the terminal may include information on each of a DRX cycle, an on-duration timer, or a DRX inactivity timer.

The terminal may transition to an active sleep state from the RRC connected state. The base station may instruct the terminal to perform a DRX operation, and the terminal may perform the DRX operation based on the received DRX configuration information. The base station may monitor data to be transmitted to the terminal, for example, the number of PDCCH schedulings, in the configured DRX cycle of the terminal while the terminal is performing the DRX operation (S1120).

The base station may instruct an update of the DRX cycle to the terminal based on the number of monitored PDCCH schedulings (S1130). The terminal may change the DRX cycle based on the DRX cycle update instruction of the base station. For example, the terminal may increase or decrease the current DRX cycle based on the DRX cycle update instruction.

FIG. 12 is a sequence chart illustrating an exemplary embodiment of a method for controlling a DRX operation of a terminal.

Referring to FIG. 12, for a DRX cycle update for DRX operation control of the terminal, the base station may perform two-step signaling to the terminal, such as an RRC reconfiguration request and a MAC CE. The RRC reconfiguration request may include DRX cycle update time information. The MAC CE may include an instruction for DRX cycle update.

The base station may determine DRX configuration information for the terminal and may transmit the DRX configuration information to the terminal (S1210). The DRX configuration information may include information on each of a DRX cycle, an on-duration timer, or a DRX inactivity timer. For example, the base station may set the DRX cycle to 10 ms, the on-duration timer to 2 ms, and the DRX inactivity timer to 2 ms. The base station may transmit the DRX configuration information including the configuration for the DRX cycle, the on-duration timer, or the DRX inactivity timer to the terminal.

The terminal may perform data communication with the base station in an RRC connected state and may transition to an active sleep state in the RRC connected state after a predetermined time. The base station may instruct the terminal to perform a DRX operation, and the terminal may perform the DRX operation based on the received DRX configuration information (S1220).

The base station may transmit an RRC reconfiguration request to the terminal (S1230). The RRC reconfiguration request may include DRX cycle update configuration information. The DRX cycle update configuration information may include one or more pieces of DRX cycle update time information. The update time information may include one or more update times. The update time information may be included in a PDCCH configuration (config) or DRX configuration. The update time information may be a time in units of slots or milliseconds. For example, the update time information may be set to {−4, −20, 20, 40}.

The terminal may receive the RRC reconfiguration request from the base station and may transmit an RRC reconfiguration complete to the base station in response to the RRC reconfiguration request (S1240). The base station may receive the RRC reconfiguration complete from the terminal and may monitor whether a PDCCH is scheduled for the terminal in one DRX cycle, in other words, the number of PDCCH schedulings (S1250).

The base station may instruct the terminal to update the DRX cycle based on the number of monitored PDCCH schedulings (S1260). For example, the base station may transmit to the terminal an update instruction including DRX cycle update bit information. The DRX cycle update bit information may be an index to the update time information included in the aforementioned RRC reconfiguration request. The base station may transmit the DRX cycle update instruction to the terminal through a MAC CE.

The terminal may receive the DRX cycle update instruction from the base station and may increase or decrease the corresponding DRX cycle based on the update bit information. For example, the base station may transmit a DRX cycle update instruction including the update bit information set to ‘01’. The terminal may receive the DRX cycle update instruction from the base station and, based on the update bit information set to ‘01’ included in the update instruction, may select 20 among the previously received update time information {−40, −20, 20, 40}. The terminal may increase the current DRX cycle by 20 ms based on the selected update time information.

According to an exemplary embodiment, the base station may also transmit to the terminal an update instruction including a DRX cycle index that stepwise increases or decreases the current DRX cycle of the terminal. For example, the base station may transmit to the terminal an RRC reconfiguration request including one or more pieces of DRX cycle update time information. The update time information may be set to {10 ms, 20 ms, 40 ms, 80 ms, 160 ms, 320 ms}. The base station may receive the RRC reconfiguration complete from the terminal and may monitor the number of PDCCH schedulings for the terminal in one DRX cycle. The base station may instruct the terminal to perform a DRX cycle update including a DRX cycle index based on the number of monitored PDCCH schedulings.

For example, when the current DRX cycle of the terminal is 40 ms, the DRX cycle update instruction transmitted from the base station to the terminal may include an increased DRX cycle index. Accordingly, the terminal may select 80 ms, which is increased by one step from the current DRX cycle 40 ms, among the update time information {10 ms, 20 ms, 40 ms, 80 ms, 160 ms, 320 ms}, based on the increased DRX cycle index. The terminal may increase the DRX cycle based on the selected 80 ms. According to an exemplary embodiment, the terminal may dynamically update, adaptively to a scheduling situation, DRX configuration parameters such as not only the DRX cycle but also an on-duration timer or a DRX inactivity timer configuration value.

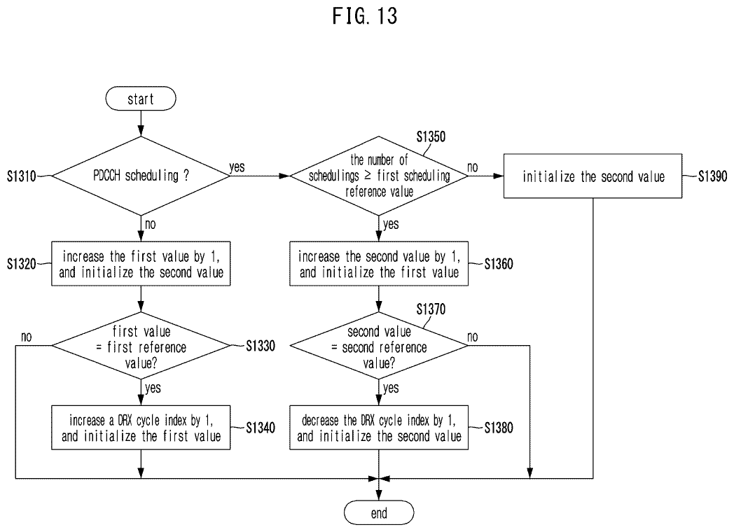

FIG. 13 is a flow chart illustrating an exemplary embodiment of a method of controlling a DRX operation of a terminal.

Referring to FIG. 13, the base station may determine DRX configuration information of the terminal and may transmit the DRX configuration information to the terminal. The DRX configuration information may include a plurality of parameters for changing a DRX cycle of the terminal.

For example, the plurality of parameters may include a first value and a second value indicating whether the terminal receives a PDCCH. The first value may be the number of times the terminal does not receive a PDCCH (e.g. N_noscheduled), and the second value may be the number of times the terminal receives a PDCCH at or above a specific ratio during the DRX cycle (e.g. N_overscheduled). The first value and the second value may be initialized to 0.

In addition, the plurality of parameters may include a first scheduling reference value and a second scheduling reference value for PDCCH reception by the terminal. The first scheduling reference value may be a value for determining that the number of PDCCH schedulings is large (e.g. overscheduled). The second scheduling reference value may be a value for determining that the number of PDCCH schedulings is small (e.g. lessscheduled). The second scheduling reference value may be set to 0.

In addition, the plurality of parameters may include a first reference value and a second reference value for dynamic control of a DRX cycle of the terminal. The first reference value may be a reference value for a DRX cycle index (e.g. N_plus). The second reference value may be a reference value for a DRX cycle index (e.g. N_minus).

The base station may schedule a PDCCH in an on-duration time of an active duration during the DRX cycle of the terminal. The terminal may determine whether the scheduled PDCCH from the base station is received (S1310).

The terminal may not receive the PDCCH from the base station. The terminal may increase the preconfigured first value by 1 and may initialize the preconfigured second value (S1320). The terminal may compare the first value with the first reference value (S1330). When the first value is equal to the first reference value, the terminal may increase a DRX cycle index value by 1 and may initialize the first value (S1340). Accordingly, the terminal may increase the current DRX cycle based on the increased DRX index value.

In addition, the terminal may receive the scheduled PDCCH from the base station. The terminal may compare the number of PDCCH receptions with the first scheduling reference value (S1350).

When the number of PDCCH receptions is equal to or greater than the first scheduling reference value, the terminal may increase the preconfigured second value by 1 and may initialize the preconfigured first value (S1360). In addition, when the number of PDCCH receptions is less than the first scheduling reference value, the terminal may initialize the preconfigured second value (S1390).

The terminal may compare the second value with the second reference value (S1370). When the second value is equal to the second reference value, the terminal may decrease the DRX cycle index by 1 and may initialize the second value (S1380). Accordingly, the terminal may decrease the current DRX cycle based on the decreased DRX index value.

As described above, in the present exemplary embodiment, the terminal may dynamically control the DRX cycle to be increased or decreased based on the number of PDCCH receptions during the DRX cycle. Accordingly, the terminal may reduce power consumption according to the increased DRX cycle and may prevent an increase in data transmission delay time according to the decreased DRX cycle.

Meanwhile, the base station may determine DRX configuration information for the DRX operation of the terminal and may transmit the DRX configuration information to the terminal. The base station may receive UE assistance information including preferred DRX parameters from the terminal and may determine the DRX configuration information of the terminal based on DRX assistance information included in the UE assistance information. The DRX assistance information may include DRX assistance information for at least one of battery state information of the terminal, data reception state information of the terminal, scheduling policy preference information of the terminal, or paging policy preference information of the terminal.

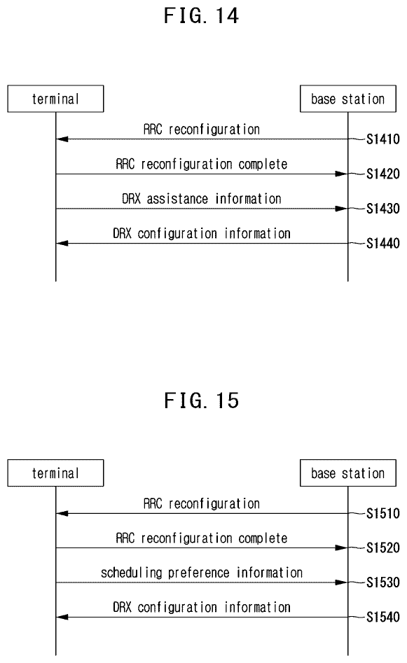

FIG. 14 is a sequence chart illustrating an exemplary embodiment of a method of determining DRX configuration information of a terminal.

Referring to FIG. 14, the base station may transmit an RRC reconfiguration request to the terminal (S1410). The RRC reconfiguration request may include a request that the terminal report DRX assistance information (e.g. DRXAssistance). The base station may configure, in configuration information such as otherConfig or DRX-Config of the RRC reconfiguration request, the terminal to report DRX assistance information.

The terminal may transmit an RRC reconfiguration complete to the base station in response to the RRC reconfiguration request received from the base station (S1420).

The terminal may report UE assistance information (e.g. UEAssistanceInformation) to the base station periodically or upon occurrence of an event based on a DRX assistance information request included in the RRC reconfiguration request. The UE assistance information may include DRX assistance information (S1430).

According to an exemplary embodiment, the terminal may transmit the UE assistance information including the DRX assistance information to the base station through a MAC CE. According to an exemplary embodiment, the terminal may transmit the UE assistance information including the DRX assistance information to the base station through a PDCP or SDAP control PDU. In addition, when the terminal periodically transmits the UE assistance information to the base station, the terminal may operate a timer (e.g. prohibit timer) to prevent the transmission of the UE assistance information for a specific time.

The DRX assistance information may include battery state information of the terminal. The battery state information of the terminal may include charging state information. The terminal may periodically report the battery charging state information to the base station or may report the battery charging state information to the base station when the charging state information of the previous DRX assistance information differs from the current charging state information.

In addition, the battery state information may include current remaining battery level information. The terminal may periodically report the current remaining battery level information to the base station or may report the current remaining battery level information to the base station when a difference between the remaining battery level information of the previous DRX assistance information and the current remaining battery level information is greater than or equal to a preset threshold value. According to an exemplary embodiment, the terminal may also report the current remaining battery level information to the base station when a variation of the remaining battery level over a specific time is greater than or equal to a threshold value.

The DRX assistance information may include data reception state information of the terminal. The data reception state information of the terminal may include data reception delay state information.

The terminal may periodically report the data reception delay state information to the base station or may report the data reception delay state information to the base station when a difference between the data reception delay state information of the previous DRX assistance information and the current data reception delay state information is greater than or equal to a preset threshold value. The data reception delay state information may be information per Quality of Service (QoS) flow, per data bearer, or averaged information for all data bearers.

In addition, the data reception state information may include reception data occurrence cycle state information. The terminal may periodically report the reception data occurrence cycle state information to the base station or may report the current reception data occurrence cycle state information to the base station when a difference between the reception data occurrence cycle state information of the previous DRX assistance information and the current reception data occurrence cycle state information is greater than or equal to a threshold value. According to an exemplary embodiment, the terminal may also report the reception data occurrence cycle state information to the base station when the reception data occurrence cycle state information is greater than or equal to a threshold value. The reception data occurrence cycle state information may be information per QoS flow, per data bearer, or averaged information for all data bearers.

In addition, the data reception state information may include reception data jitter state information. The terminal may periodically report the reception data jitter state information to the base station or may report the current reception data jitter state information to the base station when a difference between the reception data jitter state information of the previous DRX assistance information and the current reception data jitter state information is greater than or equal to a threshold value. According to an exemplary embodiment, the terminal may also report the reception data jitter state information to the base station when the reception data jitter state information is greater than or equal to the threshold value. The reception data jitter state information may be information per QoS flow, per data bearer, or averaged information for all data bearers.

The base station may receive the UE assistance information from the terminal and may determine DRX configuration information for the terminal based on the DRX assistance information included in the UE assistance information. For example, the base station may determine the DRX configuration information of the terminal based on the battery state information of the terminal or the data reception state information of the terminal among the DRX assistance information. The base station may transmit the determined DRX configuration information to the terminal (S1440).

FIG. 15 is a sequence chart illustrating an exemplary embodiment of a method of determining DRX configuration information of a terminal.

Referring to FIG. 15, the base station may transmit an RRC reconfiguration request to the terminal (S1510). The RRC reconfiguration request may include a request for the terminal to report scheduling policy preference information. The base station may configure, in configuration information such as otherConfig or DRX-Config of the RRC reconfiguration request, the terminal to report the scheduling policy preference information.

The terminal may transmit an RRC reconfiguration complete to the base station in response to the RRC reconfiguration request received from the base station (S1520). The terminal may report UE assistance information to the base station based on the scheduling policy preference information request included in the RRC reconfiguration request (S1530). The UE assistance information may include scheduling policy preference information (e.g. scheduling-Preference).

According to an exemplary embodiment, the terminal may transmit the UE assistance information including the scheduling policy preference information to the base station through a MAC CE. According to an exemplary embodiment, the terminal may transmit the UE assistance information including the scheduling policy preference information to the base station through a PDCP or SDAP control PDU. In addition, when the terminal periodically transmits the UE assistance information to the base station, the terminal may also operate a timer to prevent the transmission of the UE assistance information for a specific time.

The scheduling policy preference information may include scheduling preference information of the terminal. For example, when the scheduling preference information indicates ‘normal’, it may indicate that the terminal prefers a general scheduling policy. When the scheduling preference information indicates ‘only_OnDuration’, it may indicate that the terminal requests scheduling only during an on-duration time. When the scheduling preference information indicates ‘underX_InactivityTimer’, it may indicate that the terminal requests scheduling only during a time corresponding to X (e.g. 50%) or less of the inactivity timer.

The scheduling policy preference information may include delay-tolerant scheduling information. The delay-tolerant scheduling information may be information that requests scheduling when the number of downlink packets is greater than or equal to a specific number. According to an exemplary embodiment, the base station may transmit information on the number of delay-tolerant scheduling downlink packets to the terminal.

According to an exemplary embodiment, the delay-tolerant scheduling information may include an allowable delay threshold value. The allowable delay threshold value may be a value determined so that the first downlink packet of the base station allows a scheduling delay that is within the allowable delay threshold value. According to an exemplary embodiment, the delay-tolerant scheduling information may include exception situation information. The exception situation information may include a flag for determining whether to apply delay-tolerant scheduling to predefined exception situations. For example, the predefined exception situations may include cases where an urgent downlink packet or important downlink packet is scheduled. In addition, the predefined exception situations may include receiving a voice call from a specific telephone number (e.g. another terminal) or receiving two or more voice calls from the same number. The terminal may include the specific number in the scheduling policy preference information. According to an exemplary embodiment, the base station may also obtain the specific number based on subscriber information of the terminal.

The base station may receive the UE assistance information from the terminal and may determine DRX configuration information for the terminal based on the scheduling policy preference information included in the UE assistance information. For example, the base station may determine the DRX configuration information of the terminal based on the scheduling preference information of the terminal or the delay-tolerant scheduling information among the scheduling policy preference information. The base station may transmit the determined DRX configuration information to the terminal (S1540).

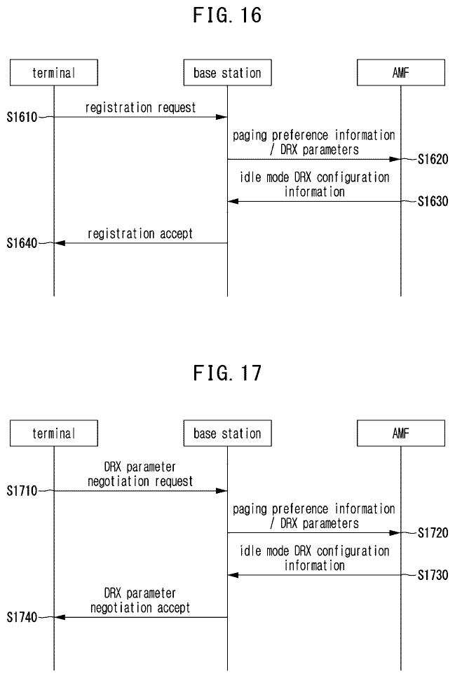

FIG. 16 is a sequence chart illustrating an exemplary embodiment of a method of determining DRX configuration information of a terminal.

Referring to FIG. 16, the terminal may transmit a registration request including paging policy preference information to the base station (S1610). The paging policy preference information may include IDLE mode DRX parameters preferred by the terminal. The terminal may transmit the registration request including the paging policy preference information to the base station when the paging policy preference information is changed.

The paging policy preference information of the terminal may include delay-tolerant paging information. The delay-tolerant paging information may be information that requests paging when the number of downlink packets is greater than or equal to a specific number. According to an exemplary embodiment, the base station may transmit information on the number of delay-tolerant paging downlink packets to the terminal.

According to an exemplary embodiment, the delay-tolerant paging information may include an allowable delay threshold value. The allowable delay threshold value may be a value determined so that the first downlink packet of the base station allows a paging delay that is within the allowable delay threshold value. According to an exemplary embodiment, the delay-tolerant paging information may include exception situation information. The exception situation information may include a flag for determining whether to apply delay-tolerant paging to predefined exception situations. For example, the predefined exception situations may include cases where an urgent downlink packet or important downlink packet is scheduled. In addition, the predefined exception situations may include receiving a voice call from a specific telephone number (e.g. another terminal) or receiving two or more voice calls from the same number. The terminal may include the specific number in the paging policy preference information. According to an exemplary embodiment, the base station may also obtain the specific number based on subscriber information of the terminal.

The base station may receive a registration request from the terminal and may transmit the paging policy preference information of the terminal included in the registration request to a core network, for example, an Access and Mobility Management Function (AMF) (S1620).

The AMF may receive the paging policy preference information of the terminal from the base station. The AMF may determine idle mode DRX configuration information of the terminal based on the paging policy preference information.

The AMF may transmit the determined idle mode DRX configuration information to the base station (S1630). The base station may receive the idle mode DRX configuration information from the AMF and may transmit a registration accept including the idle mode DRX configuration information to the terminal (S1640).

FIG. 17 is a sequence chart illustrating an exemplary embodiment of a method of determining DRX configuration information of a terminal.

Referring to FIG. 17, the terminal may transmit a DRX parameter negotiation request including paging policy preference information to the base station (S1710). The base station may receive the negotiation request from the terminal and may transmit the paging policy preference information of the terminal included in the negotiation request to the AMF (S1720).

The paging policy preference information of the terminal may include delay-tolerant paging information, and the delay-tolerant paging information may include an allowable delay threshold value or exception situation information.

The AMF may determine idle mode DRX configuration information of the terminal based on the paging policy preference information. The AMF may transmit the determined idle mode DRX configuration information to the base station (S1730). The base station may receive the DRX configuration information from the AMF and may transmit a DRX parameter negotiation accept including the DRX configuration information to the terminal (S1740).

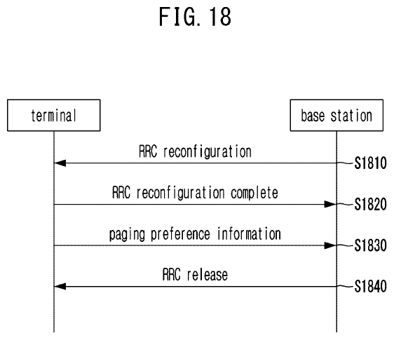

FIG. 18 is a sequence chart illustrating an exemplary embodiment of a method of determining DRX configuration information of a terminal.

Referring to FIG. 18, the base station may transmit an RRC reconfiguration request to the terminal (S1810). The RRC reconfiguration request may include a request for the terminal to report radio access network (RAN) paging policy preference information (e.g. paging-Preference). The base station may configure, in configuration information such as otherConfig or DRX-Config of the RRC reconfiguration request, the terminal to report the RAN paging policy preference information.

The terminal may transmit an RRC reconfiguration complete to the base station in response to the RRC reconfiguration request received from the base station (S1820). The terminal may report UE assistance information to the base station periodically or upon occurrence of an event based on the RAN paging policy preference information request included in the RRC reconfiguration request. The UE assistance information may include the RAN paging policy preference information (S1830). When the terminal periodically transmits the UE assistance information to the base station, the terminal may operate a timer to prevent transmission of the UE assistance information for a specific time.

The RAN paging policy preference information of the terminal may include delay-tolerant RAN paging information. The delay-tolerant RAN paging information may be information that requests paging when the number of downlink packets is greater than or equal to a specific number. According to an exemplary embodiment, the base station may transmit information on the number of delay-tolerant RAN paging downlink packets to the terminal.

According to an exemplary embodiment, the delay-tolerant RAN paging information may include an allowable delay threshold value. The allowable delay threshold value may be a value determined so that the first downlink packet of the base station allows an RAN paging delay that is within the allowable delay threshold value. According to an exemplary embodiment, the delay-tolerant RAN paging information may include exception situation information. The exception situation information may include a flag for determining whether to apply delay-tolerant RAN paging to predefined exception situations. For example, the predefined exception situations may include cases where an urgent downlink packet or important downlink packet is scheduled. In addition, the predefined exception situations may include receiving a voice call from a specific telephone number (e.g. another terminal) or receiving two or more voice calls from the same number. The terminal may include the specific number in the RAN paging policy preference information. According to an exemplary embodiment, the base station may also obtain the specific number based on subscriber information of the terminal. According to an exemplary embodiment, the RAN paging policy preference information may include values such as ran-PagingCycle or t380 preferred by the terminal.

The base station may receive UE assistance information from the terminal and may determine idle mode DRX configuration information of the terminal based on the RAN paging policy preference information included in the UE assistance information. The base station may transmit an RRC release including the idle mode DRX configuration information as SuspendConfig to the terminal (S1840). According to an exemplary embodiment, SuspendConfig may include values such as ran-PagingCycle or t380 preferred by the terminal.

According to an exemplary embodiment, the terminal may apply the dynamic control method of the DRX cycle described above to a paging operation. For example, the AMF may configure the idle mode DRX cycle information of the terminal by transmitting DRX configuration information including the idle mode DRX cycle information of the terminal in a registration accept message. The idle mode DRX cycle information of the terminal may include one or more DRX cycle configuration information items. The terminal may increase or decrease a DRX cycle index of the idle mode DRX cycle based on whether the paging of the base station occurs during the idle mode DRX cycle, and accordingly, the terminal may dynamically control the idle mode DRX cycle. The terminal may synchronize the idle mode DRX cycle with the AMF.

The terminal may receive DRX configuration information including Mminus information and Mplus information from the base station. Each of the Mminus information and the Mplus information may be information for determining the size of the DRX cycle index that can dynamically control the idle mode DRX cycle of the terminal. When an idle mode DRX cycle in which paging is continuously received is Mminus, the terminal may decrease the DRX cycle index by 1. Accordingly, the terminal may decrease the idle mode DRX cycle. In addition, when an idle mode DRX cycle in which paging is not continuously received is Mplus, the terminal may increase the DRX cycle index by 1. Accordingly, the terminal may increase the idle mode DRX cycle.

According to an exemplary embodiment, the terminal may also apply the dynamic control method of the DRX cycle described above to the RAN paging operation. The configuration of applying the dynamic control method of the DRX cycle to the RAN paging operation of the terminal may be the same as the configuration of applying the dynamic control method of the DRX cycle to the paging operation of the terminal described above.

According to an exemplary embodiment, the terminal may perform a paging operation using multiple PagingUE-Identities. For example, the terminal may configure two or more PagingUE-Identities, and may configure different idle mode DRX parameters for each PagingUE-Identity. One of the multiple PagingUE-Identities may be used for the existing paging operation of the terminal. Another one of the multiple PagingUE-Identities may be used for the paging operation of predefined exception situations among delay-tolerant paging operations of the terminal. The predefined exception situations may include cases where an urgent downlink packet or important downlink packet is scheduled. In addition, the predefined exception situations may include receiving a voice call from a specific telephone number (e.g. another terminal) or receiving two or more voice calls from the same number.

The terminal may configure the idle mode DRX cycle for the paging operation of the exception situations to be shorter than the idle mode DRX cycle for the existing paging operation. Accordingly, the terminal can reduce the transmission delay time for urgent or important data to receive it quickly and can reduce power consumption for general data.

The base station (or AMF) may determine a PagingUE-Identity for the paging operation of the exception situations of the terminal and may transmit the determined PagingUE-Identity to the terminal. According to an exemplary embodiment, the terminal may also determine the PagingUE-Identity for exception situation paging from the existing PagingUE-Identity based on preconfigured rules.

When the terminal is able to connect to two or more networks, the terminal may perform the paging operation using multiple PagingUE-Identities. The two or more networks may include a network in which the power consumption for maintaining the connection of the terminal is relatively high and a network in which the power consumption is relatively low.

For example, a situation may be assumed where the terminal is mounted on a vehicle and the vehicle is moving. In this case, when the terminal is connected to the base station and maintains the network connection, power consumption of the terminal may increase due to frequent cell reselection or TA update operations. Accordingly, the terminal may reduce power consumption by increasing the idle mode DRX cycle using one of the PagingUE-Identities used for the existing terminal paging among the multiple PagingUE-Identities. In addition, when the terminal maintains the network connection by connecting to a U2N Relay in the vehicle, the terminal may decrease the idle mode DRX cycle using another one of the PagingUE-Identities used for exception situation paging among the multiple PagingUE-Identities.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, discontinuous reception (DRX) configuration information;
performing physical downlink control channel (PDCCH) monitoring in an active duration of a DRX cycle based on the DRX configuration information;
receiving, from the base station, instruction information instructing adjustment of the active duration of the DRX cycle;
adjusting a time length of the active duration based on the instruction information from the base station; and
performing PDCCH monitoring in the active duration whose time length is adjusted.

2. The method according to claim 1, wherein the adjusting of the time length of the active duration comprises:
receiving, from the base station, a radio resource control (RRC) reconfiguration including extension time information of the active duration;
receiving, from the base station, an extension instruction for the active duration; and
extending the time length of the active duration based on the extension time information according to the extension instruction.

3. The method according to claim 1, wherein the adjusting of the time length of the active duration comprises:
receiving, from the base station, an RRC reconfiguration including short inactivity timer information;
receiving, from the base station, a final data scheduling indication for the active duration; and
reducing the time length of the active duration based on the short inactivity timer information according to the final data scheduling indication.

4. The method according to claim 1, further comprising: controlling the DRX cycle by receiving information instructing an update of the DRX cycle from the base station.

5. The method according to claim 4, wherein the controlling of the DRX cycle comprises:
receiving, from the base station, an RRC reconfiguration including update information for the DRX cycle;
receiving, from the base station, an update instruction for the DRX cycle; and
increasing or decreasing the DRX cycle based on the update information according to the update instruction.

6. The method according to claim 4, wherein the DRX configuration information includes a first reference value and a second reference value set for a number of PDCCH receptions during the DRX cycle, and the controlling of the DRX cycle comprises:
determining a number of receptions of PDCCHs transmitted from the base station during the DRX cycle; and
decreasing a DRX cycle index when the number of receptions of PDCCHs is equal to the first reference value, and increasing the DRX cycle index when the number of receptions of PDCCHs is equal to the second reference value.

7. The method according to claim 1, further comprising:
receiving, from the base station, an RRC reconfiguration including a DRX assistance information request; and
transmitting, to the base station, user equipment (UE) assistance information including at least one DRX assistance information,
wherein the DRX configuration information is determined based on the at least one DRX assistance information.

8. The method according to claim 7, wherein the at least one DRX assistance information includes at least one of: battery state information, data reception state information, scheduling policy preference information, or paging policy preference information of the terminal.

9. The method according to claim 1, wherein the performing of the PDCCH monitoring in the active duration comprises:
in response to the terminal transitioning from an RRC connected state to an active sleep state, receiving a DRX operation instruction from the base station; and
performing the PDCCH monitoring in the active duration based on the DRX configuration information according to the DRX operation instruction.

10. A terminal comprising at least one processor, wherein the at least one processor causes the terminal to perform:
receiving, from a base station, discontinuous reception (DRX) configuration information;
performing physical downlink control channel (PDCCH) monitoring in an active duration of a DRX cycle based on the DRX configuration information;
receiving, from the base station, instruction information instructing adjustment of the active duration of the DRX cycle;
adjusting a time length of the active duration based on the instruction information from the base station; and
performing PDCCH monitoring in the active duration whose time length is adjusted.

11. The terminal according to claim 10, wherein in the adjusting of the time length of the active duration, the at least one processor causes the terminal to perform:
receiving, from the base station, a radio resource control (RRC) reconfiguration including extension time information of the active duration;
receiving, from the base station, an extension instruction for the active duration; and
extending the time length of the active duration based on the extension time information according to the extension instruction.

12. The terminal according to claim 10, wherein in the adjusting of the time length of the active duration, the at least one processor causes the terminal to perform:
receiving, from the base station, an RRC reconfiguration including short inactivity timer information;
receiving, from the base station, a final data scheduling indication for the active duration; and
reducing the time length of the active duration based on the short inactivity timer information according to the final data scheduling indication.

13. The terminal according to claim 10, wherein the at least one processor further causes the terminal to perform: controlling the DRX cycle by receiving information instructing an update of the DRX cycle from the base station.

14. The terminal according to claim 11, wherein in the controlling of the DRX cycle, the at least one processor causes the terminal to perform:
receiving, from the base station, an RRC reconfiguration including update information for the DRX cycle;
receiving, from the base station, an update instruction for the DRX cycle; and
increasing or decreasing the DRX cycle based on the update information according to the update instruction.

15. The terminal according to claim 10, wherein the at least one processor further causes the terminal to perform:
receiving, from the base station, an RRC reconfiguration including a DRX assistance information request; and
transmitting, to the base station, user equipment (UE) assistance information including at least one DRX assistance information,
wherein the DRX configuration information is determined based on the at least one DRX assistance information.

16. The terminal according to claim 15, wherein the at least one DRX assistance information includes at least one of: battery state information, data reception state information, scheduling policy preference information, or paging policy preference information of the terminal.

17. The terminal according to claim 10, wherein in the performing of the PDCCH monitoring in the active duration, the at least one processor causes the terminal to perform:
in response to the terminal transitioning from an RRC connected state to an active sleep state, receiving a DRX operation instruction from the base station; and
performing the PDCCH monitoring in the active duration based on the DRX configuration information according to the DRX operation instruction.

18. A method of a base station, comprising:
determining discontinuous reception (DRX) configuration information of a terminal;
transmitting the DRX configuration information to the terminal;
predicting whether a physical downlink control channel (PDCCH) is to be scheduled in an inactive duration of a DRX cycle of the terminal; and
based on a prediction that a PDCCH is to be scheduled in the inactive duration, transmitting information instructing extension of an active duration to the terminal, and based on a prediction that a PDCCH is not to be scheduled in the inactive duration, transmitting information indicating a final data scheduling for the active duration to the terminal.

19. The method according to claim 18, further comprising:
transmitting an RRC reconfiguration to the terminal, the RRC reconfiguration including update information for increasing or decreasing the DRX cycle;
monitoring a number of PDCCH schedulings for the active duration of the DRX cycle; and
transmitting an update instruction of the DRX cycle to the terminal based on the number of monitored PDCCH schedulings.

20. The method according to claim 18, further comprising:
transmitting an RRC reconfiguration including a DRX assistance information request to the terminal; and
receiving user equipment (UE) assistance information including at least one DRX assistance information from the terminal,
wherein the DRX configuration information is determined based on the at least one DRX assistance information.
